(19) United States
(12) Patent Application Publication
(10) Pub. No.: US 2009/0249442 A1
(43) Pub. Date: Oct. 1, 2009

(54) ENABLING SELECTED COMMAND ACCESS

(76) Inventors: Gregory Clare Birgen, Pflugerville, TX (US); Michael Andrew Bockus, Manor, TX (US); Frank Paul Feuerbacher, Austin, TX (US); Michael William Panico, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 12/057,481

(22) Filed: Mar. 28, 2008

(51) Int. Cl. G06F 7/04

(52) U.S. Cl. 726/2

(57) ABSTRACT

A method, medium and implementing processing system are provided for enabling access to specific privileged commands that are required to successfully execute tasks within an application only to individuals assigned a predetermined role to perform such tasks. In one example, the system administrator defines roles that contain the authorizations needed in order to provide the granularity of security that the users' company has defined. Once the system administrator defines the roles and assigns them to the users, then each user will have the authorizations needed in order to authenticate with the console and perform the system management tasks that they have been assigned. Thus, a web console consisting of a collection of web applications is enabled with the functionality to restrict access to privileged commands necessary to perform selected system management tasks.

### FIELD OF THE INVENTION

The present invention relates generally to information processing systems and more particularly to a methodology and implementation for authorizing command access in console applications.

### BACKGROUND OF THE INVENTION

Computer software and hardware systems are often configured, monitored and managed by one or more administrators using graphic user interfaces called “consoles”. Often each system component within an information technology (IT) environment has its own independently developed console for carrying out required operations. All businesses require a number of computer based software and/or hardware products to produce business solutions and a large business or other enterprise may have a very large number of such products in its IT environment.

As used in the art, the term “console” generally refers to, inter alia, a software user interface containing applications used to monitor and manage a system. A web console provides software support for users to allow user access to system operations through a user web browser on a system, which may include desktop computers, laptop computers, servers, personal and other devices, coupled in a system configuration using hard-wire or wireless interconnections. A central controlled distributed scalable virtual machine (CCDSVM) allows a control server to control a group of systems and provide distributed services to a client system in Internet and Intranet and/or local area network (LAN) environments.

Providing a secure web console that can be adaptable to fit every customer's needs is a very difficult problem. Nearly every customer works in an environment that is unique to their business. This unique environment introduces different types of security constraints for each customer. Delivering a console that can conform to each customer's constraints is a difficult task. In many cases, when delivering a system management web console, it is not known how a customer's IT infrastructure is set up or how the system management tasks are to be divided among administrators.

Therefore, a solution is needed to provide system administrators with ability to assign designated roles to selected individuals and to grant access to such individuals to only the privileged commands necessary to perform tasks inherent to such designated roles.

### SUMMARY OF THE INVENTION

A method, medium and implementing processing system are provided for enabling access to specific privileged commands that are required to successfully execute tasks within an application only to individuals assigned a predetermined role to perform such tasks. In one example, the system administrator defines roles that contain the authorizations needed in order to provide the granularity of security that the users' company has defined. Once the system administrator defines the roles and assigns them to the users, then each user will have the authorizations needed in order to authenticate with the console and perform the system management tasks that they have been assigned. Thus, a web console consisting of a collection of web applications is enabled with the functionality to restrict access to privileged commands necessary to perform selected system management tasks.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of a server in accordance with the present invention;

FIG. 3 is an illustration of a displayed console application screen useful in explaining an exemplary operation of the present invention;

FIG. 4 is an illustration of a displayed console application screen using an exemplary implementation of the present invention; and

FIG. 5 is a flow chart illustrating an operational sequence in an exemplary implementation of the present invention.

### DETAILED DESCRIPTION

The various methods discussed herein may be implemented within a computer system which includes processing means, memory, updateable storage, input means and display means. Since the individual components of a computer system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a console server application, it is understood that disclosed methodology may also be applied in many other available and future devices and systems to achieve the beneficial functional features described herein.

The disclosed security solution provides adaptability and control in defining the security definitions for a console. It enables the ability to provide software solutions that can be customized to fit security needs for many different information management systems. In accordance with the present invention, each administrator will only be able to access the tasks inside the console that they are authorized to execute.

In the example, the console consists of a collection of web applications that provide the functionality to perform system management tasks on a machine. Access to the web console is controlled by the authentication methods that currently exist on the machine. For example, on some systems, access to the console is restricted to the users defined on that system. Once a user is authenticated, a solution is needed to ensure that a user has the right authorizations to perform tasks using the web applications contained in the console.

The disclosed methodology allows the applications to define what authorizations a user needs in order to successfully execute tasks within the application. Authorizations, in this context, give a user access to one or more privileged commands on the server. The system administrator is enabled to define roles that contain the authorizations needed in order to provide the granularity of security that his/her company has defined. Once the system administrator defines the roles and assigns them to the users, then each user will have the authorizations needed in order to authenticate with the console and perform the system management tasks that have been assigned to them.

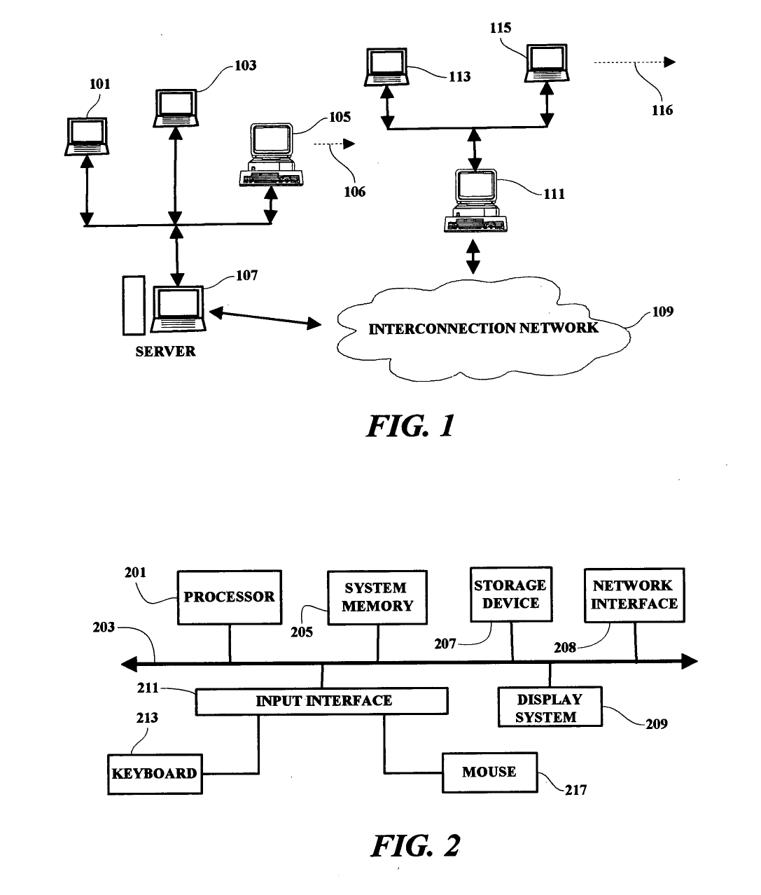

FIG. 1 illustrates an exemplary interconnection network within which the present invention may be implemented. As shown, a series of computer devices 101, 103 and 105 are coupled to a console server system 107 to form a networked system. The computer devices may be laptop computers, desktop computers or other computing devices 106 which are connected to access the server 107 and the programs contained in the console. In the illustrated example, the console server system 107 has unlimited access and control of all commands and functions within the console. The console 107, in turn, is arranged to assign various limited roles to other computers in the network as will be hereinafter explained in greater detail.

The console server 107 may also be coupled through an interconnection network 109 to other computer systems, for example, to computers 111, 113 and 115 and others 116 as shown. In the illustrated exampled, the console server 107 may designate and enable computers 105 and 111 as secondary servers to perform limited server console functions for the other computers in the sub-networks, i.e. computers 101 and 103 for secondary server 105, and computers 113 and 115 for secondary server 111.

FIG. 2 illustrates several of the major components in a typical computer system which may be implemented as a server or one of the computer systems shown in FIG. 1. As shown, a processor system 201 is connected to a main bus 203. System memory 205 and a system storage device 207 are shown connected to the main bus 203. A network interface 208 and an input interface 211 are also coupled to the main bus. The input interface 211 may include a keyboard 213 and/or a mouse or pointing device 217 and/or any other input means. A display system is also coupled to the main bus 203. Other components and systems may also be coupled to the main bus 203 but are not shown.

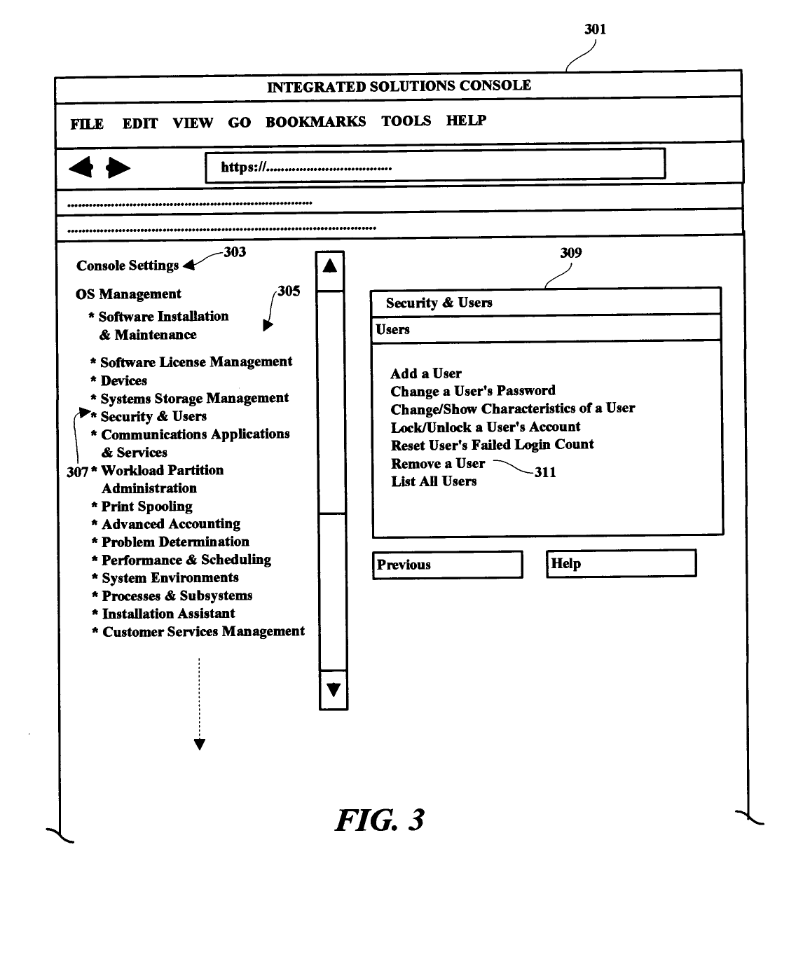

The console server 107 includes a console application to manage various server administrator functions. An exemplary console home screen 301 is illustrated in FIG. 3. Each of the console settings 303 and functions performed or enabled 305 by the server system 107 is listed on the integrated solutions console screen 301. For purposes of explanation, the “Security and Users” area is highlighted 307 and shown in detail 309 as one of the console server functions that may be managed by the administrator of the console server. It is noted that one of the functions within the Security and Users area is the ability to “Remove a User” 311 as shown.

The displayed navigation area shows that there are numerous web applications deployed in the console. Each application contained within the console provides a user with the capabilities to perform a known list of tasks. For example, the application “Security and Users” provides a set of tasks for managing users and groups on a system. If a system administrator wanted to assign a user the responsibilities of managing users and groups, and to not have access to rest of the console, he/she could do that using an implementation of the present invention.

First, the developer of the “Security and Users” application, knows exactly what commands need to he executed on the system in order to perform the tasks within the application. Each command that is used to manage users and groups on the system is considered a privileged command. Each privileged command is assigned an authorization. For a system user to have the ability to execute a privileged command, they must obtain a role that contains that authorization. Each application is delivered with a list of authorizations that are needed in order to execute tasks successfully within the application.

Second, the developer has provided the list of authorizations needed in order to execute a list of tasks in an application. For example, in the “Security and Users” application the developer for an AIX application has documented that a user of this application must have the following authorizations to execute ail user and group management tasks:

aix.security.user aix.security.user.change

aix.security.user,create aix.security.user.create.admin

aix.security.user.create.normal aix.security.user.list

aix.security.user.remove

aix.security.group aix.security.group.change

aix.security.group.create aix.security.group.list

aix.security.group.remove

The system administrator now has the ability to create a role containing any subset of these authorizations. This provides the granularity in order to conform to any security definition a customer might have. For example, If a customer wants to have one system administrator to manage all users and groups, but not have the ability to remove users and groups, they could create and assign that system administrator a role containing the following authorizations:

aix.security.user.change aix.security.user.create

aix.security.user.create.admin

aix.security.user.create.normal aix.security.user.list

aix.security.group.change aix.security.group.create

aix.security.group.list

Now the system administrator responsible for managing security and users will be able to successfully log into the console and perform all user and group management tasks except for the “removal” function.

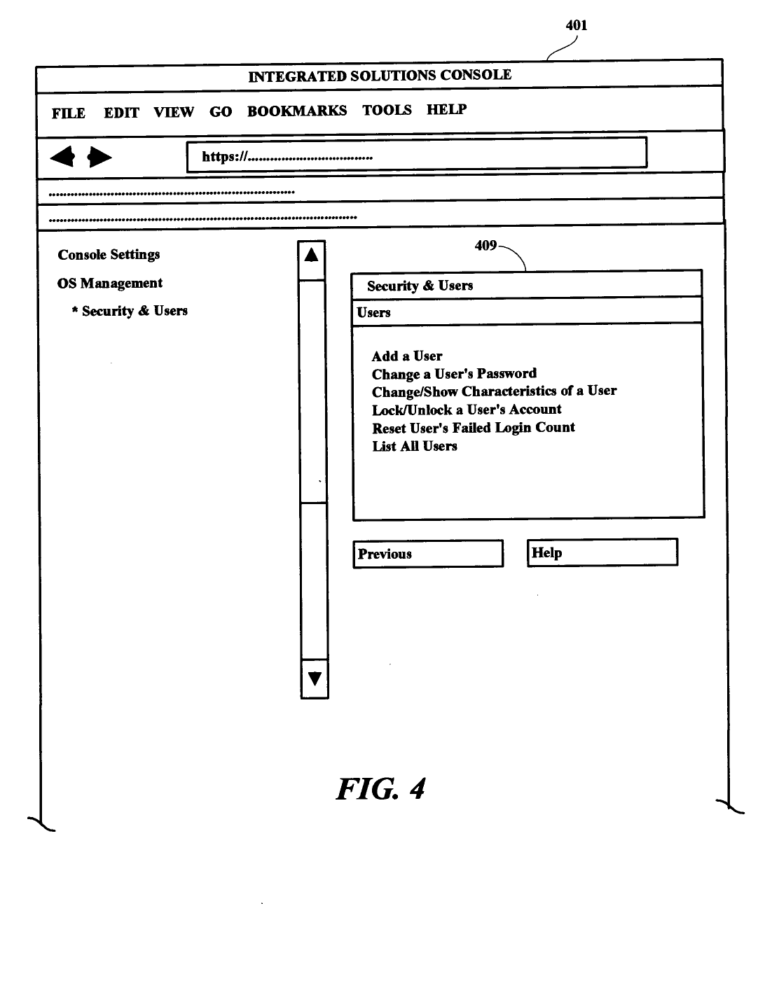

FIG. 4 shows how the console screen 401 would look if a user who had been assigned this newly created role logged into the console. Notice that now none of the other applications are shown in the screen navigation area besides the “Security and Users” application 409. Also notice that the “Remove a User” link within the application is not rendered since they do not have the authorization to remove users.

The console screen 401 displays only the applications and tasks to which the user has access. In this case, the user has been restricted to only managing users and groups using the “Security and Users” application. They do not have the capability to remove users or groups. The roles assigned to users can be dynamically altered in order to conform to changes in the security definitions. Authorizations can be added and removed from roles and roles can be added and removed from users. The console will dynamically acknowledge any changes that have been made to the security definitions on the system. This security solution provides customers an easy way to assign different system management tasks to different employees. This method ensures that all tasks can be performed without having to worry about employees altering parts of the system that they haven't been authorized to change.

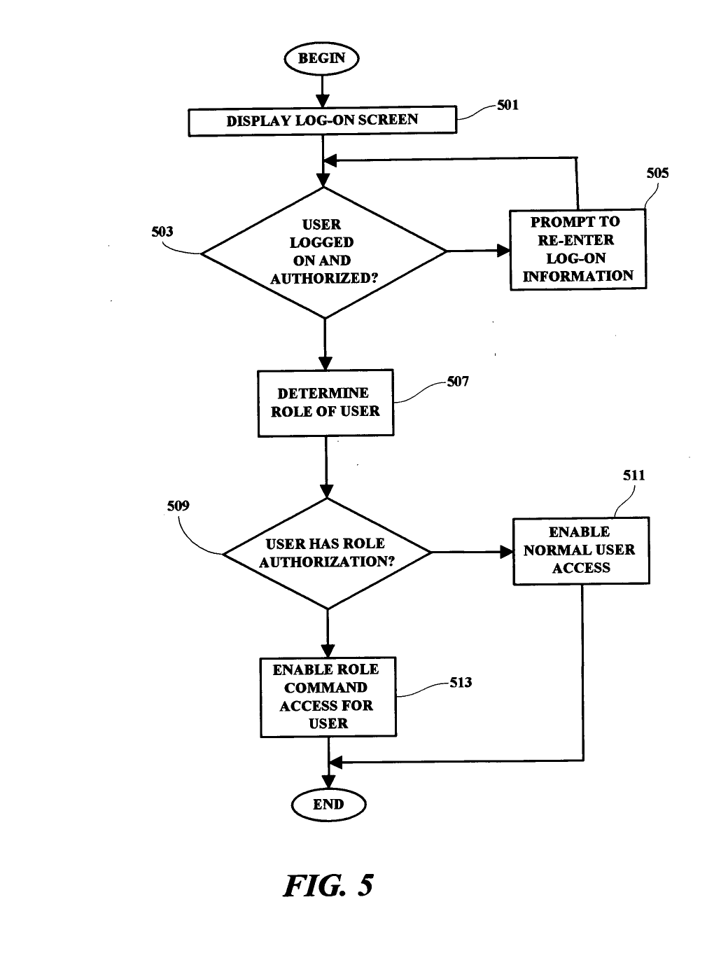

FIG. 5 illustrates an exemplary operational sequence which may be implemented in code running on the console server 107. As shown, when the process begins, a log-on screen is displayed 501 on a user computer, if the user is not properly authorized 503, the user is prompted to re-enter the system log-on information 505. Once the user logs-on and is determined to be an authorized user 503, a determination is made, for example by referring to a server database, as to the “role” of the user 507 as the user's role has been predetermined by the administrator. If it is determined that the user has not been assigned a system role 509, then the user is granted normal access 511 to the console server programming. If, however, it is determined that the user has been assigned a special “role” to play 509 in the operation of the console, then the user is enabled to access the predetermined privileged commands and/or functions 513 necessary to perform the assigned role, as shown, for example, in FIG. 4.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing a privileged command set, said privileged command set being executable by a network console administrator to accomplish a predetermined network function for users of a network, said method comprising:
receiving a log-on request from a user on said network;
verifying said user as an authorized user of said network;
determining a network role assigned to said user; and
enabling access to said user to predetermined commands of said privileged command set which are required by said user to execute said network role.

2. The method as set forth in claim 1 wherein said network role of said user is predetermined by said network console administrator.

3. The method as set forth in claim 1 and further including a network memory containing associations between users and network roles of said users.

4. The method as set forth in claim 1 and further including:
excluding selected ones of said privileged command set to which said user is granted access, said excluded commands being unnecessary for said user to execute said network role of said user.

5. The method as set forth in claim 1 and further including:
displaying only said predetermined commands on a display unit of said user for execution of said displayed commands by said user.

6. The method as set forth in claim 1 wherein said network includes a local area network (LAN).

7. The method as set forth in claim 1 wherein said network includes a wide area network (WAN).

8. The method as set forth in claim 1 wherein said network includes user devices coupled wirelessly in said network.

9. A medium programmed for processing a privileged command set, said privileged command set being executable by a network console administrator to accomplish a predetermined network function for users of a network, said medium being readable by a computing device for providing program signals effective for:
receiving a log-on request from a user on said network;
verifying said user as an authorized user of said network;
determining a network role assigned to said user; and
enabling access to said user to predetermined commands of said privileged command set which are required by said user to execute said network role.

10. The medium as set forth in claim 9 wherein said network role of said user is predetermined by said network console administrator.

11. The medium as set forth in claim 9 and further including a network memory containing associations between users and network roles of said users.

12. The medium as set forth in claim 9 wherein said program signals are further effective for:
excluding selected ones of said privileged command set to which said user is granted access, said excluded commands being unnecessary for said user to execute said network role of said user.

13. The medium as set forth in claim 9 wherein said program signals are further effective for:
displaying only said predetermined commands on a display unit of said user for execution of said displayed commands by said user.

14. The medium as set forth in claim 9 wherein, said network includes a local area network (LAN).

15. The medium as set forth in claim 9 wherein said network includes a wide area network (WAN).

16. The medium as set forth in claim 9 wherein said network includes user devices coupled wirelessly in said network.

17. A system for processing a privileged command set, said privileged command set being executable by a network console administrator to accomplish a predetermined network function for users of a network, said medium being readable by a computing device for providing program signals, said system further including:
means for receiving a log-on request from a user on said network;
means for verifying said user as an authorized user of said network;
means for determining a network role assigned to said user; and
means for enabling access to said user to predetermined commands of said privileged command set which are required by said user to execute said network role.

18. The system as set forth in claim 17 wherein said network role of said user is predetermined by said network console administrator.

19. The system as set forth in claim 17 and further including a network memory containing associations between users and network roles of said users.

20. The system as set forth in claim 17 and further including means for excluding selected ones of said privileged command set to which said user is granted access, said excluded commands being unnecessary for said user to execute said network role of said user.
